(19) United States
(12) Patent Application Publication
(10) Pub. No.: US 2026/0209493 A1
(43) Pub. Date: Jul. 23, 2026

(54) HYBRID RECYCLED POLYPROPYLENE COMPOUNDS FOR PACKAGING CLOSURES

(71) Applicant: Fina Technology, Inc., Houston, TX (US)

(72) Inventors: Peng Li, Sugar Land, TX (US); Joachim Azzi, Houston, TX (US); Russell McDonald, Humble, TX (US); Fengkui Li, Houston, TX (US); Mohammad Tuhin, Houston, TX (US)

(73) Assignee: Fina Technology, Inc., Houston, TX (US)

(21) Appl. No.: 19/441,592

(22) Filed: Jan. 6, 2026

Related U.S. Application Data
(60) Provisional application No. 63/746,451, filed on Jan. 17, 2025.

(51) Int. Cl. C08L 23/12; B65D 33/16; B65D 65/38; C08J 3/20; C08J 3/22

(52) U.S. Cl. CPC C08L 23/12; B65D 33/1625; B65D 65/38; C08J 3/203; C08J 3/226; B65D 2565/384; C08J 2323/12; C08J 2423/12; C08L 2205/025; C08L 2207/20; C08L 2310/00

(57) ABSTRACT

A recycled polypropylene formulation comprising virgin polypropylene in an amount ranging from greater than or equal to about 0 weight percent (wt %) to less than or equal to about 99 wt %, and recycled polypropylene in an amount ranging from greater than or equal to 1 wt % to less than or equal to about 100 wt %, based on a total weight of the virgin polypropylene and the recycled polypropylene; and a mineral filler.

### CROSS REFERENCE TO RELATED APPLICATIONS

This application claims priority to U.S. provisional patent application Ser. No. 63/746,451 filed Jan. 17, 2025, and entitled “Hybrid Recycled Polypropylene Compounds for Packaging Closures,” which is hereby incorporated herein by reference in its entirety for purposes not contrary to this disclosure.

### STATEMENT REGARDING FEDERALLY SPONSORED RESEARCH OR DEVELOPMENT

Not applicable.

### TECHNICAL FIELD

The disclosure relates generally to polypropylene. More particularly, the disclosure relates to polypropylene compounds for packaging closures. Still more particularly, the present disclosure relates to recycled polypropylene compounds for packaging closures.

### BACKGROUND

Packaging closures have been widely used in the packaging industry. Such closures are designed to be simple and user-friendly, securely holding bags closed to maintain freshness and preservation. These closure clips are typically manufactured via a sheet extrusion process, to be, for example, approximately 0.1 inch thick. Commercially available closure clips are typically made of polystyrene. However, a sustainable alternative to polystyrene, which provides similar mechanical strength and durability, would be beneficial.

### SUMMARY

These and other needs in the art are addressed in one embodiment by a recycled polypropylene formulation comprising virgin polypropylene in an amount ranging from greater than or equal to about 0 weight percent (wt %) to less than or equal to about 99 wt %, and recycled polypropylene in an amount ranging from greater than or equal to 1 wt % to less than or equal to about 100 wt %, based on a total weight of the virgin polypropylene and the recycled polypropylene; and a mineral filler.

These and other needs in the art are addressed in another embodiment by a packaging closure comprising a recycled polypropylene formulation comprising virgin polypropylene in an amount ranging from greater than or equal to about 0 weight percent (wt %) to less than or equal to about 99 wt %, and recycled polypropylene in an amount ranging from greater than or equal to 1 wt % to less than or equal to about 100 wt %, based on a total weight of the virgin polypropylene and the recycled polypropylene; and a mineral filler, wherein the packaging closure exhibits a flexural modulus, as determined according to ASTM D790, in a range of greater than or equal to about 200 kpsi to less than or equal to about 600 kpsi (alternatively in a range of from greater than or equal to about 300 kpsi to less than or equal to about 500 kpsi).

These and other needs in the art are addressed in another embodiment by a method of producing a packaging closure, the method comprising: forming (e.g., in an extruder) resin pellets comprising a polypropylene formulation and a mineral filler, wherein the polypropylene formulation comprises virgin polypropylene in an amount ranging from greater than or equal to about 0 weight percent (wt %) to less than or equal to about 99 wt %, and recycled polypropylene in an amount ranging from greater than or equal to 1 wt % to less than or equal to about 100 wt %, based on a total weight of the virgin polypropylene and the recycled polypropylene; and extruding the resin pellets to produce the packaging closure.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF DRAWINGS

For a detailed description of various exemplary embodiments, reference will now be made to the accompanying drawings in which:

FIG. 1 is a schematic of bread-bag clips, which are an example of a packaging closure that can be made from polypropylene, rather than polystyrene, materials, according to embodiments of this disclosure;

FIG. 2 is a bar graph of the melt flow rate (dg/min) of various samples designated Comparative Virgin Polypropylene Compound No. 1 (CC1), Hybrid Recycled Polypropylene Compound No. 1 (HC1), and Hybrid Recycled Polypropylene Compound No. 2 (HC2) of the Example;

FIG. 3 is a bar graph of the flexural modulus (kpsi) of CC1, HC1, and HC2 of the Example;

FIG. 4 is a bar graph of the tensile yield strength (psi) of CC1, HC1, and HC2 of the Example; and

FIG. 5 is a bar graph of the Izod impact strength (ft-lb/in) of CC1, HC1, and HC2 of the Example.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . ” As used herein, the phrases “consist(s) of” and “consisting of” are used to refer to exclusive components of a composition, meaning only those expressly recited components are included in the composition; whereas the phrases “consist(s) essentially of” and “consisting essentially of” are used to refer to the primary components of a composition, meaning that only small or trace amounts of components other than the expressly recited components (e.g., impurities, byproducts, etc.) may be included in the composition. For example, a composition consisting of X and Y refers to a composition that only includes X and Y, and thus, does not include any other components; and a composition consisting essentially of X and Y refers to a composition that primarily comprises X and Y, but may include small or trace amounts of components other than X and Y. In some embodiments described herein, any such small or trace amounts of components other than those expressly recited following the phrase “consist(s) essentially of” or “consisting essentially of” preferably represent less than 5.0 wt % of the composition, more preferably less than 4.0 wt % of the composition, even more preferably less than 3.0 wt % of the composition, and still more preferably less than 1.0 wt % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Disclosed herein are recycled polypropylene formulations (also referred to herein as “recycled polypropylene compounds”) containing recycled polypropylene. In some of the embodiments disclosed herein, the recycled polypropylene formulations may be suitably employed in packaging closure applications. Specifically, the disclosed recycled polypropylene formulations may comprise virgin polypropylene in an amount ranging from greater than or equal to about 0, 0.1, 0.2, 0.3, 0.4, or 0.5 weight percent (wt %) to less than or equal to about 99 wt % and recycled polypropylene (e.g., PCR (post-consumer recyclates), PIR (post-industrial recyclates), or mixed PCR/PIR) in an amount ranging from greater than or equal to about 1 wt % to less than or equal to about 100 wt %. The recycled polypropylene (e.g., the PCR and/or PIR) may be either FDA compliant or non-FDA compliant. As utilized herein, FDA-compliant refers to the recycled polypropylene (PCR or PIR) being suitable for food-contact applications, while non-FDA compliant indicates that the recycled polypropylene doesn't meet FDA regulations/standards, and therefore should not be used for food-contact applications.

In some embodiments, detailed further below, the recycled polypropylene may contain small amounts of polyethylene or other contaminants. Also as detailed further below, one or more mineral fillers, including calcium carbonate, talc, or other known agents, may be added to improve the mechanical strength and stiffness of the packaging closure comprising the recycled polypropylene formulation. The recycled polypropylene formulation can be used in applications of current virgin resin-based polypropylene or polystyrene packaging closures.

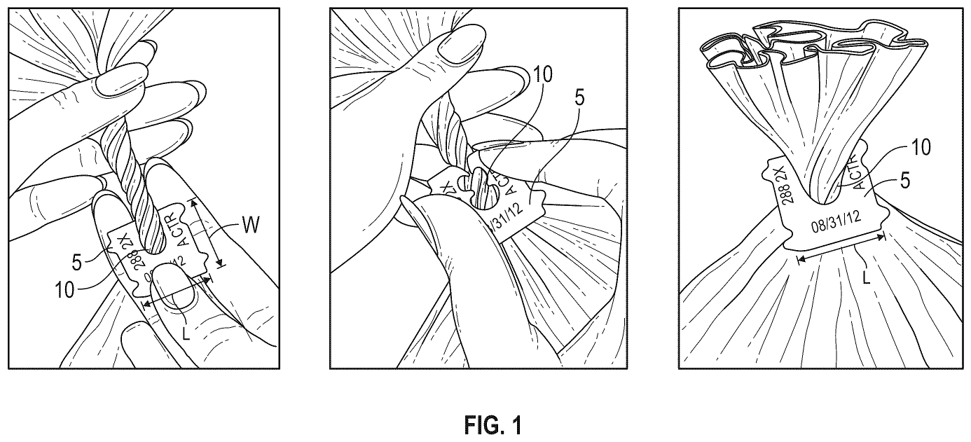

Packaging closure applications include closures for a variety of packages. For example, in some embodiments, the packaging closure comprises a (e.g., bread) bag clip, such as depicted in FIG. 1, which is a schematic of bread-bag clips, which can be made, as detailed hereinbelow, from the disclosed recycled polypropylene formulations.

As noted above, packaging closures, for example, a bag clip as disclosed herein, have been widely used in the packaging industry, and are designed to be simple and user-friendly, securely holding bags closed to maintain freshness and preservation. Commercially available closure clips are typically made of polystyrene, which imparts superior mechanical strength and durability to the closure clips, making them suitable for repeated use. The polypropylene compounds disclosed herein are formulated with mineral fillers, such as calcium carbonate and talc, which make yield desirable mechanical properties, as will be disclosed herein, for use in such packaging closure applications, for example, mechanical properties substantially similar to those of polystyrene when similarly employed.

Disclosed herein is a recycled polypropylene formulation comprising recycled polypropylene. In some embodiments, the recycled polypropylene formulation comprises virgin polypropylene in addition to recycled polypropylene, and may be referred to herein as a hybrid recycled polypropylene composition. According to this disclosure, a virgin polypropylene includes a polypropylene that has not been previously utilized in a product; a recycled polypropylene includes a polypropylene that has previously been utilized in a product; a hybrid recycled polypropylene includes a polypropylene that includes virgin and recycled polypropylene.

The recycled polypropylene formulation can comprise virgin polypropylene in an amount ranging from greater than or equal to about 0, 0.1, 0.2, 0.3, 0.4, or 0.5 wt % to less than or equal to about 99 wt % or alternatively comprising the virgin polypropylene in an amount ranging from greater than or equal to about 30 wt % to less than or equal to about 70 wt %, based on a total weight of the virgin polypropylene and the recycled polypropylene; and recycled polypropylene in an amount ranging from greater than or equal to 1 wt % to less than or equal to about 100 wt %, or alternatively comprising the recycled polypropylene in an amount ranging from greater than or equal to about 70 wt % to less than or equal to about 30 wt %, based on a total weight of the virgin polypropylene and the recycled polypropylene. For example, in some embodiments, the recycled polypropylene formulations of this disclosure may comprise polypropylene (e.g., a total of the virgin polypropylene and the recycled polypropylene) in an amount of greater than or equal to about 10 wt %, 20 wt %, 30 wt %, or 40 wt % polypropylene to less than or equal to about 70 wt %, 80 wt %, or 90 wt % polypropylene, based on a total weight of the formulation. In some embodiments, the recycled polypropylene formulation comprises 100% recycled polypropylene, based on a total weight of the formulation. In other embodiments, the recycled polypropylene formulation is a hybrid recycled polypropylene formulation comprising both virgin and recycled polypropylene.

In various embodiments, the virgin polypropylene, the recycled polypropylene, or both can comprise a homopolymer, a copolymer, an impact copolymer (also referred to as a heterophasic copolymer), or a combination thereof. The virgin polypropylene, the recycled polypropylene, or both may comprise a Ziegler-Natta-catalyzed polypropylene, a metallocene-catalyzed polypropylene, or a combination thereof. The virgin polypropylene can comprise a reactor powder polypropylene.

In some embodiments, the virgin polypropylene, the recycled polypropylene, or both may comprise a homopolymer. In some embodiments, the homopolymer can further comprise up to 5% of another alpha-olefin, examples of which include, but not limited to, C2-C8 alpha-olefins, such as ethylene and 1-butene. The polypropylene homopolymer can be atactic polypropylene, isotactic polypropylene, hemi-isotactic polypropylene, syndiotactic polypropylene, or a combination thereof. A polymer is “atactic” when its pendant groups are arranged in a random fashion on both sides of the chain of the polymer. A polymer is “isotactic” when all of its pendant groups are arranged on the same side of the chain. A polymer is “syndiotactic” when its pendant groups alternate on opposite sides of the chain. A polymer is hemi-isotactic polymer when every other repeat unit has a random substituent.

In some embodiments, the virgin polypropylene, the recycled polypropylene, or both may comprise an impact copolymer. Impact copolymer is a type of polypropylene resin that is modified with ethylene-propylene rubber to, for example, improve its toughness and impact strength. Impact copolymer may be produced in two or more reactors, where the first reactor polymerizes the polypropylene homopolymer matrix and the second reactor polymerizes the rubber phase that is dispersed in the matrix. Impact copolymer can also be referred to as heterophasic copolymer. In other embodiments, the virgin polypropylene, the recycled polypropylene, or both may comprise a polypropylene heterophasic copolymer in which a polypropylene homopolymer phase or component is joined to a copolymer phase or component. For example, the virgin polypropylene, the recycled polypropylene, or both may comprise ethylene in an amount ranging from greater or equal to than 0 wt %, 0.1 wt %, 1 wt %, 2 wt %, 3 wt %, 4 wt %, 5 wt %, 6 wt %, or 6.5 wt % to less than or equal to 20 wt %, 10 wt %, 9 wt %, 8 wt %, 7 wt %, 6 wt %, 5 wt %, 4 wt %, 3 wt %, 2 wt %, 1 wt %, 0.5 wt %, or 0.1 wt % by total weight of the virgin polypropylene, the recycled polypropylene, or both, respectively, additionally or alternatively, from greater than or equal to 8.5 wt % to less than or equal to 18 wt % or, additionally or alternatively, from greater than or equal to 9.5 wt % to less than or equal to 16%. In some embodiments, the copolymer phase can comprise a random copolymer of propylene and ethylene, also referred to as an ethylene/propylene rubber (EPR). Polypropylene impact copolymers may exhibit distinct homopolymer phases that are interrupted by short sequences or blocks having a random arrangement of ethylene and propylene. In comparison to random copolymers, the block segments comprising the EPR may have certain polymeric characteristics (e.g., intrinsic viscosity) that differ from that of the copolymer as a whole. Without wishing to be limited by theory, the EPR portion of the impact copolymer can have rubbery characteristics which, when incorporated within the matrix of the homopolymer component, can function to provide increased impact strength to the polypropylene heterophasic copolymer. In some embodiments, the EPR portion of the polypropylene heterophasic copolymer comprises greater than or equal to 14 wt % of the polypropylene heterophasic copolymer, additionally or alternatively, greater than or equal to 18 wt % of the polypropylene heterophasic copolymer, additionally or alternatively, ranging from greater than or equal to 14 wt % to less than or equal to 18 wt % of the polypropylene heterophasic copolymer.

The amount of ethylene present in the EPR portion of the polypropylene heterophasic copolymer may range from greater than or equal to 38 wt % to less than or equal to 60 wt %, additionally or alternatively, from greater than or equal to 40 wt % to less than or equal to 45 wt %, based on the total weight of the EPR portion. In an embodiment, the polypropylene heterophasic copolymer may have a MFR of from greater than or equal to 1 decigrams per minute (dg/min) to 100 dg/min, additionally or alternatively, greater than or equal to from 1.5 dg/min. to less than or equal to 50 dg/min.

In some embodiments, virgin polypropylene, the recycled polypropylene, or both comprises a polypropylene homopolymer. The polypropylene homopolymer may have a density of from greater than or equal to 0.895 g/cm³ to less than or equal to 0.920 g/cm³, additionally or alternatively, from greater than or equal to 0.900 g/cm³ to less than or equal to 0.915 g/cm³ or, additionally or alternatively, from greater than or equal to 0.905 g/cm³ to less than or equal to 0.915 g/cm³, as determined in accordance with ASTM D1505. In some embodiments, the propylene homopolymer can have a MFR ranging from greater than or equal to 0.5 dg/min to less than or equal to 100 dg/min, additionally or alternatively, from greater than or equal to 1 dg/min to less than or equal to 30 dg/min or, additionally or alternatively, ranging from greater than or equal to 1 dg/min to less than or equal to 10 dg/min as measured by ASTM D1238.

The virgin polypropylene can have a MFR, according to ASTM D1238 in a range of from greater than or equal to about 0.5 dg/min to less than or equal to about 100 dg/min, from greater than or equal to about 1 dg/min to less than or equal to about 30 dg/min, or from greater than or equal to about 1 dg/min to less than or equal to about 10 dg/min. The virgin polypropylene can be a reactor grade polypropylene or a vis-broken grade polypropylene.

As noted above, the recycled polypropylene may comprise post industrial recycled (PIR) polypropylene post consumer recycled (PCR) polypropylene, or a combination thereof. The recycled polypropylene may be FDA-compliant or non-FDA compliant for food contact use.

The recycled polypropylene may comprise polypropylene in an amount ranging from greater than or equal to about 50 wt % to less than or equal to about 100 wt %, additionally or alternatively, in an amount ranging from greater than or equal to about 60 wt % to less than or equal to about 100 wt %, additionally or alternatively, in an amount ranging from greater than or equal to about 70 wt % to less than or equal to about 100 wt %. The recycled polypropylene may thus further comprise polyethylene and/or one or more other non-polypropylene components in an amount ranging greater than or equal to 0 wt % to less than or equal to about 80 wt %, additionally or alternatively, from greater than or equal to 0 wt % to less than or equal to about 70 wt %, additionally or alternatively, from greater than or equal to 0 wt % to less than or equal to about 60 wt %, additionally or alternatively, from greater than or equal to 0 wt % to less than or equal to about 50 wt %, additionally or alternatively, from greater than or equal to 0 wt % to less than or equal to about 40 wt % or, additionally or alternatively, in an amount ranging from greater than or equal to 0 wt % to less than or equal to about 30 wt %.

The recycled polypropylene formulation may further comprise a mineral filler. Suitable mineral fillers include, without limitation, calcium carbonate, talc, another inorganic agent, or a combination thereof. The recycled polypropylene formulation may comprise a total amount of the virgin polypropylene and the recycled polypropylene ranging from greater than or equal to about 40 wt % to less than or equal to about 90 wt %, and the mineral filler in an amount ranging from greater than or equal to 10 wt % to less than or equal to about 60 wt %, based on a total weight of the recycled polypropylene formulation. In some embodiments, the recycled polypropylene formulation comprises from greater than or equal to about 0 wt %, 10 wt %, 20 wt %, 30 wt %, 40 wt %, 50 wt %, or 60 wt % to less than or equal to about 60 wt %, 50 wt %, 40 wt %, 30 wt %, 20 wt %, or 10 wt % of the one or more mineral fillers

The recycled polypropylene formulation may further comprise one or more additives. For example, such additional additives may include one or more additional additives selected from primary and secondary antioxidants, neutralizers, color pigments, dispersing agents, impact modifiers, or a combination thereof.

The recycled polypropylene formulation may have a melt flow rate, as determined according to ASTM D1238, ranging from greater than or equal to about 0.5 decigrams/minute (dg/min) to less than or equal to about 20 dg/min, alternatively ranging from greater than or equal to about 1 dg/min to less than or equal to about 10 dg/min, or alternatively ranging from greater than or equal to about 0.1 dg/min to less than or equal to about 30 dg/min. The virgin polypropylene may have a melt flow rate, as determined according to ASTM D1238, ranging from greater than or equal to about 0.5 decigrams/minute (dg/min) to less than or equal to about 100 dg/min, alternatively ranging from greater than or equal to about 1 dg/min to less than or equal to about 30 dg/min, or alternatively ranging from greater than or equal to about 1 dg/min to less than or equal to about 10 dg/min. The recycled polypropylene may have a melt flow rate, as determined according to ASTM D1238, ranging from greater than or equal to about 0.5 decigrams/minute (dg/min) to less than or equal to about 100 dg/min, alternatively ranging from greater than or equal to about 1 dg/min to less than or equal to about 30 dg/min, or alternatively ranging from greater than or equal to about 1 dg/min to less than or equal to about 10 dg/min.

In some embodiments, the mineral filler may be effective to adjust a mechanical property of the recycled polypropylene formulation, for example, such that the recycled polypropylene formulation exhibits one or more mechanical properties (e.g., flexural modulus) to enable the recycled polypropylene formulation to be suitably employed as a packaging closure. In some embodiments, the recycled polypropylene formulation provides the packaging closure with a flexural modulus, as determined according to ASTM D790, in a range of greater than or equal to about 200 kpsi to less than or equal to about 600 kpsi, additionally or alternatively, in a range of from greater than or equal to about 300 kpsi to less than or equal to about 500 kpsi or, additionally or alternatively, in a range of from greater than or equal to about 200 kpsi to less than or equal to about 500 kpsi.

In some embodiments, the recycled polypropylene formulation as disclosed herein may exhibit a flexural modulus, as measured according to ASTM D790, ranging from greater than or equal to about 200 kpsi to less than or equal to about 600 kpsi, additionally or alternatively ranging from greater than or equal to about 300 to less than or equal to about 500 kpsi or, additionally or alternatively ranging from greater than or equal to about 200 to less than or equal to about 500 kpsi. Additionally, in some embodiments, the recycled polypropylene formulation as disclosed herein may exhibit an Izod impact strength, as measured according to ASTM D256A, ranging from greater than or equal to about 0.3 to less than or equal to about 3 ft-lb/in, alternatively or additionally, ranging from greater than or equal to about 0.4 to less than or equal to about 3 ft-lb/in, or alternatively or additionally, ranging from greater than or equal to about 0.3 to less than or equal to about 2.5 ft-lb/in. Additionally, in some embodiments, the recycled polypropylene formulation as disclosed herein may exhibit a tensile strength at yield, as measured according to ASTM D638, ranging from greater than or equal to about 3000 to less than or equal to about 6000 psi, alternatively or additionally, ranging from greater than or equal to about 4000 to less than or equal to about 6000 psi, or alternatively or additionally, ranging from greater than or equal to about 3000 to less than or equal to about 5000 psi. Additionally, in some embodiments, the recycled polypropylene formulation as disclosed herein may exhibit a tensile strength at break, as measured according to ASTM D638, ranging from greater than or equal to about 2000 to less than or equal to about 6000 psi, alternatively or additionally, ranging from greater than or equal to about 3000 to less than or equal to about 6000 psi, or alternatively or additionally, ranging from greater than or equal to about 2000 to less than or equal to about 5000 psi. In some embodiments, the recycled polypropylene formulation as disclosed herein may exhibit a tensile elongation at yield, as measured according to ASTM D638, ranging from greater than or equal to about 2 to less than or equal to about 10%, alternatively or additionally, ranging from greater than or equal to about 3 to less than or equal to about 10%, or alternatively or additionally, ranging from greater than or equal to about 3 to less than or equal to about 10%. Additionally, in some embodiments, the recycled polypropylene formulation as disclosed herein may exhibit a tensile elongation at break, as measured according to ASTM D638, ranging from greater than or equal to about 10 to less than or equal to about 90%, alternatively or additionally, ranging from greater than or equal to about 20 to less than or equal to about 90%, or alternatively or additionally, ranging from greater than or equal to about 10 to less than or equal to about 80%. Additionally, in some embodiments, the recycled polypropylene formulation as disclosed herein may exhibit a combination of one or more of these properties.

Also disclosed herein is a product or article comprising the recycled polypropylene composition described herein. The product can be an injection molded, sheet extruded thermoformed, or extrusion blow molded product. The recycled polypropylene composition of this disclosure (e.g., pellets thereof) can be processed to make an article, such as by methods known to those of ordinary skill in the art. For example and without limitation, pellets of the recycled polypropylene formulation can be processed by injection molding, fiber extrusion, film extrusion, sheet extrusion, pipe extrusion, blow molding, rotomolding, slush molding, injection-stretch blow molding or extrusion-thermoforming to produce an article. Without limitation, the article can be a packaging closure configured for closing a package, such as, and without limitation, a bread clip for closing a bread bag, such as the bread clip 5 as depicted in FIG. 1, a rigid packaging, a cutlery application, or a another application for which the polypropylene composition is suited in view of its properties as described herein. The packaging closure can, for example, be of a circular, rectangular, or square shape, with a diameter, length L, and/or width W of greater than or equal to about 1, 1.5, or 2 inches (25, 51, or 76 mm) and less than or equal to about 4, 3, or 2 inches (102, 76, or 51 mm), and can have a thickness, for example, of less than or equal to about 0.05, 0.06, 0.7, 0.08, 0.9, or 0.1 inch (1.3, 1.5, 1.8, 2.0, 2.3, or 2.5 mm). The packaging closure (e.g., bread clip) can have an opening 10 designed to hold an end of a package (e.g., a bread bag) closed. Although depicted as a rectangular bread clip 5 with a semicircular opening 10 in the embodiment of FIG. 1, other suitable sizes and shapes of packaging closures will be apparent to those of skill in the art and with the help of this disclosure, and such other packaging closures are within the scope of this disclosure.

It has been unexpectedly discovered that recycled polypropylene compounds/formulations of this disclosure may be utilized in place of virgin resin-based polypropylene or polystyrene resins in (e.g., opaque) packaging closures. The recycled polypropylene formulation can exhibit a flexural modulus, as determined according to ASTM D790, in a range of greater than or equal to about 200 kpsi to less than or equal to about 600 kpsi (alternatively in a range of from greater than or equal to about 300 kpsi to less than or equal to about 500 kpsi), making it suitable for use in packaging closure applications in which such flexural moduli may be beneficial.

Also disclosed herein is a method of producing a packaging closure from the above disclosed recycled polypropylene formulations. The method of producing the packaging closure may comprise forming (e.g., in an extruder) resin pellets comprising the recycled polypropylene formulation described hereinabove and a mineral filler; and extruding the resin pellets to produce the packaging closure. Forming the resin pellets may comprise forming pellets of the recycled polypropylene formulation, and extruding the pellets of the recycled polypropylene formulation with amounts of the mineral filler to make the (new) pellets that are then extruded to produce the packaging closure; or extruding masterbatch pellets comprising the recycled polypropylene formulation and a concentrated amount of the mineral filler with pellets of the recycled polypropylene formulation to produce the packaging closure. As noted above, extruding the resin pellets to produce the packaging closure can comprise sheet extrusion.

Recycled polypropylene formulations of this disclosure comprise a combination of virgin polypropylene resin and recycled polypropylene resin. Many commercially available PIR or PCR resins contain small amounts of polyethylene or other contaminates, making it difficult for clear film or sheet applications where clarity and low gels are essential. However, for opaque packaging closures, recycled polypropylene formulations of this disclosure may be combined/compounded with amounts of mineral fillers (e.g., CaCO₃ or talc). Such recycled polypropylene formulations may be less sensitive to “contaminants” or “impurities” in recycled polypropylene or hybrid recycled polypropylene formulations. This disclosure provides unique recycled polypropylene formulations for packaging closures that take advantage of cost-competitive recycled polypropylene materials.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

To further illustrate various illustrative embodiments of the present invention, the following Example is provided.

### EXAMPLE

The disclosure having been generally described, the following Example shows particular embodiments of the disclosure. It is understood that the Example is given by way of illustration and is not intended to limit the specification or the claims. All compositions percentages given in the examples are by weight.

In the Example, various polypropylene compounds were produced from TotalEnergies homopolymer 3281 virgin polypropylene, to study sustainable recycled polypropylene solutions for potential packaging closure applications. The virgin polypropylene 3281 had a MFR of 1.3 dg/min, a tensile yield strength of 4900 psi according to ASTM D638, and a flexural modulus of 200 kpsi according to ASTM D790. Recycled polypropylene formulations, shown in Table 1, comprising PIR (post-industrial recyclates) and PCR (post-consumer recyclates) were compounded and studied. The formulations studied incorporated 40% CaCO₃ mineral filler, as 825E-type polystyrene designed for sheet extrusion applications only exhibit a flexural modulus of about 320 kpsi, and the design of The Example was to match the mechanical strength of the polystyrene formulation via the recycled polypropylene formulations of this disclosure. The recycled polypropylene formulations were formulated with 20 wt % recycled polypropylene content. From a customer manufacturing standpoint, the process may, as noted above, also involve the direct use of mineral fillers in masterbatch form, eliminating the need for pre-compounding of the polypropylene(s) and the mineral filler(s) (e.g., here the CaCO₃) utilized in this Example. The single-pellet polypropylene recycled polypropylene compounds utilized here contain around 33 wt % recycled polypropylene content before the incorporation of the CaCO₃ mineral filler.

Comparative Compound 1 comprised 60 wt % of the virgin polypropylene and 40 wt % of the mineral filler CaCO₃; hybrid recycled polypropylene compound HC1 comprised 40 wt % of the virgin polypropylene, 40 wt % of the calcium carbonate filler (CaCO₃), and 20 wt % of recycled PIR polypropylene comprising Custom Polymer 65, which comprised ethylene content (C2) of less than 1% according to Nuclear Magnetic Resonance (NMR) spectroscopy analysis, having a MFR of 4 dg/min and a tensile yield strength of 4500 psi according to ASTM D638, and a flexural modulus of 195 kpsi according to ASTM D790; hybrid recycled polypropylene compound HC2 comprised 40 wt % of the virgin polypropylene, 40 wt % of the calcium carbonate filler, and 20 wt % of recycled PCR polypropylene comprising Banyan-1625, which comprised ethylene content (C2) of approximately 6.5% according to NMR spectroscopy analysis, having a MFR of 2 dg/min and a tensile yield strength of 4000 psi according to ASTM D638, and a flexural modulus of 155 kpsi according to ASTM D790. All the samples were compounded using a 27 mm REX extrusion line.

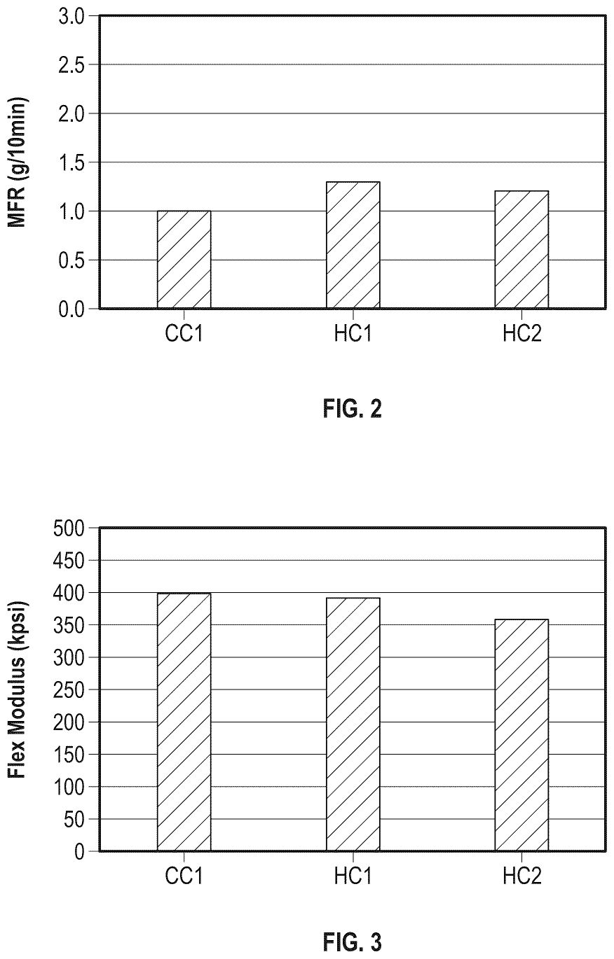

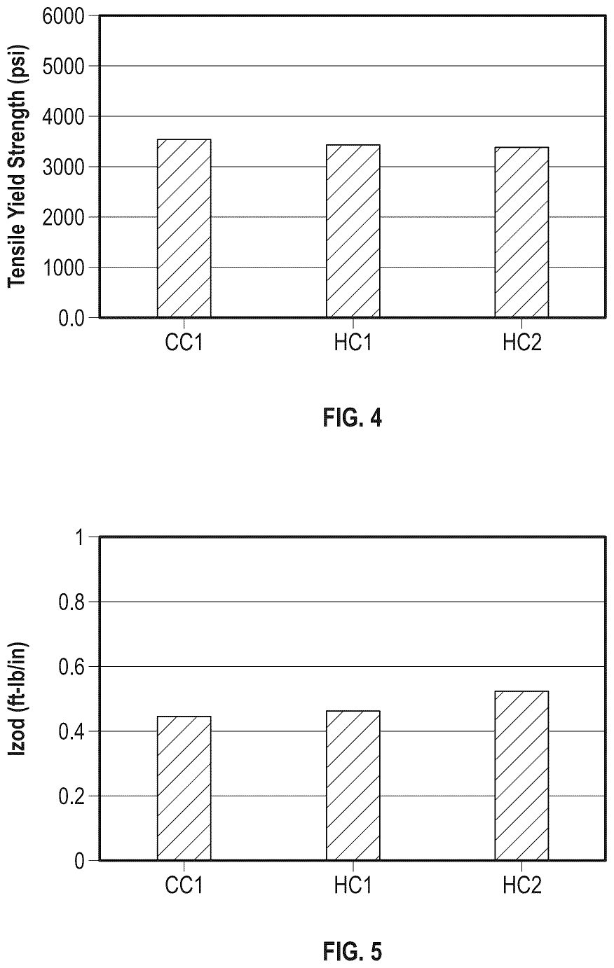

Preliminary testing results, shown in FIG. 2, which is a bar graph of the melt flow rate (dg/min) of various samples designated comparative virgin polypropylene counterpart no. 1 (CC1), hybrid recycled polypropylene compound no. 1 (HC1), and hybrid recycled polypropylene compound no. 2 (HC2), FIG. 3, which is a bar graph of the flexural modulus (kpsi) of CC1, HC1, and HC2, FIG. 4, which is a bar graph of the tensile yield strength (psi) of CC1, HC1, and HC2, and FIG. 5, which is a bar graph of the Izod impact strength (ft-lb/in) of CC1, HC1, and HC2, indicate that the hybrid recycled polypropylene formulations (HC1 and HC2) perform similarly to the comparative virgin polypropylene counterpart, CC1, in terms of flexural modulus (350-400 kpsi), melt flow rate, tensile strength and Izod impact strength. The results of the Example demonstrate the significant potential of using hybrid recycled polypropylene formulations of this disclosure comprising both virgin and recycled polypropylene for packaging closure applications.

TABLE 1
Property Analysis of Hybrid Recycled Polypropylene
Compounds (HC1 and HC2) vs. Comparative Virgin
Polypropylene Compound (CC1)

| | Hybrid Recycled | | |
|---|---|---|---|
| | Polypropylene Formulation | | |
| | CC1 | HC1 | HC2 |
| Virgin Polypropylene | 60 | 40 | 40 |
| Resin (3281), wt % | | | |
| Comments | Control | Hybrid Recycled | |
| | Comprising | Polypropylene Formulations | |
| | Virgin | Comprising Virgin and | |
| | Polypropylene | Recycled Polypropylene | |
| CaCO₃ Mineral | 40 | 40 | 40 |
| Filler, wt % | | | |
| Recycled PIR (Custom | | 20 | |
| Polymer-65), wt % | | | |
| Recycled PCR | | | 20 |
| (Banyan-1625), wt % | | | |

### ADDITIONAL DISCLOSURE

The following are non-limiting, specific embodiments in accordance with the present disclosure:

In a first embodiment, a recycled polypropylene formulation comprising virgin polypropylene in an amount ranging from greater than or equal to about 0 weight percent (wt %) to less than or equal to about 99 wt %, and recycled polypropylene in an amount ranging from greater than or equal to 1 wt % to less than or equal to about 100 wt %, based on a total weight of the virgin polypropylene and the recycled polypropylene; and a mineral filler.

A second embodiment can include the recycled polypropylene formulation of the first embodiment, wherein the virgin polypropylene comprises a polypropylene homopolymer, a random copolymer, an impact copolymer, or a combination thereof.

A third embodiment can include the recycled polypropylene formulation of the first or the second embodiment, wherein the virgin polypropylene is produced via Zieglar-Natta or metallocene catalyst.

A fourth embodiment can include the recycled polypropylene formulation of any one of the first to third embodiments, wherein the recycled polypropylene comprises post industrial recycled (PIR) polypropylene post consumer recycled (PCR) polypropylene, or a combination thereof.

A fifth embodiment can include the recycled polypropylene formulation of the fourth embodiment, wherein the recycled polypropylene is FDA-compliant or non-FDA compliant.

A sixth embodiment can include the recycled polypropylene formulation of any one of the first to fifth embodiments, wherein the recycled polypropylene comprises a homopolymer polypropylene, a random copolymer, an impact copolymer, or a combination thereof.

A seventh embodiment can include the recycled polypropylene formulation of any one of the first to sixth embodiments, wherein the recycled polypropylene comprises polypropylene in an amount ranging from greater than or equal to about 20 wt % to less than or equal to about 100 wt %.

An eighth embodiment can include the recycled polypropylene formulation of the seventh embodiment, wherein the recycled polypropylene further comprises polyethylene and/or one or more other non-polypropylene components in an amount ranging from greater than or equal to 0, 0.1, 0.5, or 1 wt % to less than or equal to about 80, 90, or 95 wt %.

A ninth embodiment can include the recycled polypropylene formulation of any one of the first to eighth embodiments, wherein the formulation has a melt flow rate, as determined according to ASTM D1238, ranging from greater than or equal to about 0.1 decigrams/minute (dg/min) to less than or equal to about 30 dg/min (alternatively ranging from greater than or equal to about 1 dg/min to less than or equal to about 10 dg/min).

A tenth embodiment can include the recycled polypropylene formulation of any one of the first to ninth embodiments, wherein the formulation exhibits a flexural modulus, as determined according to ASTM D790, in a range of greater than or equal to about 200 kpsi to less than or equal to about 600 kpsi (alternatively in a range of from greater than or equal to about 300 kpsi to less than or equal to about 500 kpsi).

An eleventh embodiment can include the recycled polypropylene formulation of any one of the first to tenth embodiments, further comprising one or more additives selected from primary and secondary antioxidants, neutralizers, color pigments, dispersing agents, impact modifiers, or a combination thereof.

A twelfth embodiment can include the recycled polypropylene formulation of any one of the first to twelfth embodiments, wherein the mineral filler selected from calcium carbonate, talc, another inorganic agent, or a combination thereof.

A thirteenth embodiment can include the recycled polypropylene formulation of the twelfth embodiment, wherein the recycled polypropylene formulation comprises a total amount of the virgin polypropylene and the recycled polypropylene ranging from greater than or equal to about 40 wt % to less than or equal to about 90 wt %, and the mineral filler in an amount ranging from greater than or equal to 10 wt % to less than or equal to about 60 wt %, based on a total weight of the recycled polypropylene formulation.

A fourteenth embodiment can include the recycled polypropylene formulation of any one of the first to thirteenth embodiments, wherein the recycled polypropylene formulation is a hybrid recycled polypropylene formulation comprising virgin polypropylene and recycled polypropylene.

In a fifteenth embodiment, a packaging closure comprises a recycled polypropylene formulation comprising virgin polypropylene in an amount ranging from greater than or equal to about 0 weight percent (wt %) to less than or equal to about 99 wt %, and recycled polypropylene in an amount ranging from greater than or equal to 1 wt % to less than or equal to about 100 wt %, based on a total weight of the virgin polypropylene and the recycled polypropylene; and a mineral filler, wherein the packaging closure exhibits a flexural modulus, as determined according to ASTM D790, in a range of greater than or equal to about 200 kpsi to less than or equal to about 600 kpsi (alternatively in a range of from greater than or equal to about 300 kpsi to less than or equal to about 500 kpsi).

A sixteenth embodiment can include the packaging closure of the fifteenth embodiment comprising a bread clip.

In a seventeenth embodiment, a method of producing a packaging closure comprises: forming (e.g., in an extruder) resin pellets comprising a polypropylene formulation and a mineral filler, wherein the polypropylene formulation comprises virgin polypropylene in an amount ranging from greater than or equal to about 0 weight percent (wt %) to less than or equal to about 99 wt %, and recycled polypropylene in an amount ranging from greater than or equal to 1 wt % to less than or equal to about 100 wt %, based on a total weight of the virgin polypropylene and the recycled polypropylene; and extruding the resin pellets to produce the packaging closure.

An eighteenth embodiment can include the method of the seventeenth embodiment, wherein forming the resin pellets comprises: forming pellets of the polypropylene formulation, and extruding the pellets of the polypropylene formulation with the mineral filler to make the pellets extruded to produce the packaging closure; or extruding masterbatch pellets comprising the polypropylene formulation and a concentrated amount of the mineral filler with pellets of the polypropylene formulation to produce the packaging closure.

A nineteenth embodiment can include the method of the seventeenth or eighteenth embodiment, wherein extruding the resin pellets to produce the packaging closure comprises sheet extrusion.

A twentieth embodiment can include the method of any one of the seventeenth to nineteenth embodiments, wherein the virgin polypropylene comprises a polypropylene homopolymer, a random copolymer, an impact copolymer, or a combination thereof.

A twenty first embodiment can include the method of any one of the seventeenth to twentieth embodiments, wherein the virgin polypropylene is produced via Zieglar-Natta or metallocene catalyst.

A twenty second embodiment can include the method of any one of the seventeenth to twenty first embodiments, wherein the recycled polypropylene comprises post industrial recycled (PIR) polypropylene post consumer recycled (PCR) polypropylene, or a combination thereof.

A twenty third embodiment can include the method of any one of the seventeenth to twenty second embodiments, wherein the recycled polypropylene is FDA-compliant or non-FDA compliant.

A twenty fourth embodiment can include the method of any one of the seventeenth to twenty third embodiments, wherein the recycled polypropylene comprises a homopolymer polypropylene, a random copolymer, an impact copolymer, or a combination thereof.

A twenty fifth embodiment can include the method of any one of the seventeenth to twenty fourth embodiments, wherein the recycled polypropylene comprises polypropylene in an amount ranging from greater than or equal to about 20 wt % to less than or equal to about 100 wt %.

A twenty sixth embodiment can include the method of any one of the seventeenth to twenty fifth embodiments, wherein the recycled polypropylene further comprises polyethylene and/or one or more other non-polypropylene components in an amount ranging from greater than or equal to 0 wt % to less than or equal to about 80 wt %.

A twenty seventh embodiment can include the method of any one of the seventeenth to twenty sixth embodiments, wherein the polypropylene formulation has a melt flow rate, as determined according to ASTM D1238, ranging from greater than or equal to about 0.1 decigrams/minute (dg/min) to less than or equal to about 30 dg/min (alternatively ranging from greater than or equal to about 1 dg/min to less than or equal to about 10 dg/min).

A twenty eighth embodiment can include the method of any one of the seventeenth to twenty seventh embodiments, wherein the polypropylene formulation exhibits a flexural modulus, as determined according to ASTM D790, in a range of greater than or equal to about 200 kpsi to less than or equal to about 600 kpsi (alternatively in a range of from greater than or equal to about 300 kpsi to less than or equal to about 500 kpsi).

A twenty ninth embodiment can include the method of any one of the seventeenth to twenty eighth embodiments, wherein the polypropylene formulation further comprises one or more additives selected from primary and secondary antioxidants, neutralizers, color pigments, dispersing agents, impact modifiers, or a combination thereof.

A thirtieth embodiment can include the method of any one of the seventeenth to twenty ninth embodiments, wherein the polypropylene formulation further comprises a mineral filler selected from calcium carbonate, talc, another inorganic agent, or a combination thereof.

A thirty first embodiment can include the method of the thirtieth embodiment, wherein the polypropylene formulation comprises a total amount of the virgin polypropylene and the recycled polypropylene ranging from greater than or equal to about 40 wt % to less than or equal to about 90 wt %, and the mineral filler in an amount ranging from greater than or equal to 10 wt % to less than or equal to about 60 wt %, based on a total weight of the polypropylene formulation.

What is claimed is:

1. A recycled polypropylene formulation, comprising:
virgin polypropylene in an amount ranging from greater than or equal to about 0 weight percent (wt %) to less than or equal to about 99 wt %;
recycled polypropylene in an amount ranging from greater than or equal to 1 wt % to less than or equal to about 100 wt %, based on a total weight of the virgin polypropylene and the recycled polypropylene; and
a mineral filler.

2. The recycled polypropylene formulation of claim 1, wherein the recycled polypropylene comprises post industrial recycled (PIR) polypropylene post consumer recycled (PCR) polypropylene, or a combination thereof.

3. The recycled polypropylene formulation of claim 1, wherein the recycled polypropylene comprises polypropylene in an amount ranging from greater than or equal to about 20 wt % to less than or equal to about 100 wt %.

4. The recycled polypropylene formulation of claim 3, wherein the recycled polypropylene further comprises polyethylene and/or one or more other non-polypropylene components in an amount ranging from greater than or equal to 0.1 wt % to less than or equal to about 80 wt %.

5. The recycled polypropylene formulation of claim 1, wherein the formulation has a melt flow rate, as determined according to ASTM D1238, ranging from greater than or equal to about 0.1 decigrams/minute (dg/min) to less than or equal to about 30 dg/min.

6. The recycled polypropylene formulation of claim 1, wherein the formulation exhibits a flexural modulus, as determined according to ASTM D790, in a range of greater than or equal to about 200 kpsi to less than or equal to about 600 kpsi.

7. The recycled polypropylene formulation of claim 1, wherein the mineral filler selected from calcium carbonate, talc, another inorganic agent, or a combination thereof.

8. The recycled polypropylene formulation of claim 7, wherein the recycled polypropylene formulation comprises a total amount of the virgin polypropylene and the recycled polypropylene ranging from greater than or equal to about 40 wt % to less than or equal to about 90 wt %, and the mineral filler in an amount ranging from greater than or equal to 10 wt % to less than or equal to about 60 wt %, based on a total weight of the recycled polypropylene formulation.

9. The recycled polypropylene formulation of claim 1, wherein the recycled polypropylene formulation is a hybrid recycled polypropylene formulation comprising virgin polypropylene and recycled polypropylene.

10. A packaging closure, comprising:
a recycled polypropylene formulation comprising virgin polypropylene in an amount ranging from greater than or equal to about 0 weight percent (wt %) to less than or equal to about 99 wt %, and recycled polypropylene in an amount ranging from greater than or equal to 1 wt % to less than or equal to about 100 wt %, based on a total weight of the virgin polypropylene and the recycled polypropylene; and
a mineral filler, wherein the packaging closure exhibits a flexural modulus, as determined according to ASTM D790, in a range of greater than or equal to about 200 kpsi to less than or equal to about 600 kpsi.

11. The packaging closure of claim 10, comprising a bread clip.

12. A method of producing a packaging closure, the method comprising:
forming resin pellets comprising a polypropylene formulation and a mineral filler, wherein the polypropylene formulation comprises virgin polypropylene in an amount ranging from greater than or equal to about 0 weight percent (wt %) to less than or equal to about 99 wt %, and recycled polypropylene in an amount ranging from greater than or equal to 1 wt % to less than or equal to about 100 wt %, based on a total weight of the virgin polypropylene and the recycled polypropylene; and
extruding the resin pellets to produce the packaging closure.

13. The method of claim 12, wherein forming the resin pellets comprises:
forming pellets of the polypropylene formulation, and extruding the pellets of the polypropylene formulation with the mineral filler to make the pellets extruded to produce the packaging closure; or
extruding masterbatch pellets comprising the polypropylene formulation and a concentrated amount of the mineral filler with pellets of the polypropylene formulation to produce the packaging closure.

14. The method of claim 12, wherein the recycled polypropylene comprises post industrial recycled (PIR) polypropylene post consumer recycled (PCR) polypropylene, or a combination thereof.

15. The method of claim 12, wherein the recycled polypropylene comprises polypropylene in an amount ranging from greater than or equal to about 20 wt % to less than or equal to about 100 wt %.

16. The method of claim 12, wherein the recycled polypropylene further comprises polyethylene and/or one or more other non-polypropylene components in an amount ranging from greater than or equal to 0.1 wt % to less than or equal to about 80 wt %.

17. The method of claim 12, wherein the polypropylene formulation has a melt flow rate, as determined according to ASTM D1238, ranging from greater than or equal to about 0.1 decigrams/minute (dg/min) to less than or equal to about 30 dg/min.

18. The method of claim 12, wherein the polypropylene formulation exhibits a flexural modulus, as determined according to ASTM D790, in a range of greater than or equal to about 200 kpsi to less than or equal to about 600 kpsi.

19. The method of claim 12, wherein the polypropylene formulation further comprises a mineral filler selected from calcium carbonate, talc, another inorganic agent, or a combination thereof.

20. The method of claim 19, wherein the polypropylene formulation comprises a total amount of the virgin polypropylene and the recycled polypropylene ranging from greater than or equal to about 40 wt % to less than or equal to about 90 wt %, and the mineral filler in an amount ranging from greater than or equal to 10 wt % to less than or equal to about 60 wt %, based on a total weight of the polypropylene formulation.
